(19) United States
(12) Patent Application Publication
(10) Pub. No.: US 2007/0286515 A1
(43) Pub. Date: Dec. 13, 2007

(54) METHOD AND APPARATUS FOR REMOVING FALSE CONTOURS

(75) Inventors: Jae-seung KIM, Yongin-si (KR); Sung-hee KIM, Seoul (KR); Rae-hong PARK, Seoul (KR); Ji-won LEE, Seoul (KR); Min-ho PARK, Seoul (KR); Hye-rin CHOI, Seoul (KR)

Correspondence Address: SUGHRUE MION, PLLC, 2100 PENNSYLVANIA AVENUE, N.W., SUITE 800, WASHINGTON, DC, 20037, US

(73) Assignees: SAMSUNG ELECTRONICS CO., LTD, Suwon-si (KR); INDUSTRY-UNIVERSITY COOPERATION FOUNDATION SOGANG UNIVERSITY, Seoul (KR)

(21) Appl. No.: 11/746,903

(22) Filed: May 10, 2007

(30) Foreign Application Priority Data
Jun. 13, 2006 (KR) 10-2006-0052872

(51) Int. Cl. G06K 9/40

(52) U.S. Cl. 382/254

(57) ABSTRACT

A method and apparatus for removing false contours while preserving edges. In the method, a false contour area is detected from an input image, false contour direction information and false contour location information of the false contour area are generated, the false contour area is expanded, and a false contour is removed from the expanded false contour area.

### CROSS-REFERENCE TO RELATED PATENT APPLICATION

This application claims priority from Korean Patent Application No. 10-2006-0052872, filed on Jun. 13, 2006, in the Korean Intellectual Property Office, the disclosure of which is incorporated herein in its entirety by reference.

### BACKGROUND OF THE INVENTION

1. Field of the Invention

The present invention relates to a method and apparatus for removing false contours, and more particularly, to a method and apparatus for removing false contours using neural networks.

2. Description of the Related Art

False contours are phenomena in which contours are observed as noise in substantially flat areas in an original input image where no contours are actually detected. False contours are noise generated during quantization for acquiring images, image compression/restoration, or image processing for improving the quality of images. False contours are likely to appear in flat areas in an image. In general, false contours are more annoying than typical noise to human eyes, and thus, methods of effectively removing false contours are needed.

FIG. 1 is a block diagram for explaining a conventional method of removing false contours. Referring to FIG. 1, the number of bits of an input image with P bits is increased to N (where N>P) by passing the input image through a low pass filter 102. Thereafter, an image output by the low pass filter 102 is quantized by a quantizer 104. A difference between the quantized image and the image output by the low pass filter 102 is added to the original input image, thereby removing false contours that appear in portions of the original input image where brightness gradually varies. Thereafter, an image obtained by the false contour removal is output.

The aforementioned conventional false contour removal method can only be applied to the situations when the number of bits of an input image is smaller than the number of bits of an output image. Thus, the scope of application of the aforementioned conventional false contour removal method is highly limited. In addition, the aforementioned conventional false contour removal method may fail to properly remove false contours when a difference between an image obtained by passing an input image through a low pass filter and an image obtained by re-quantizing is insignificant. Moreover, in the aforementioned conventional false contour removal method, false contour removal is performed on all pixels of an input image, thereby deteriorating signal components.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for removing false contours using neural networks which can remove false contours from an input image by performing false contour removal on only areas in the input image where false contours are detected while preventing edge components of the input image from deteriorating.

According to an aspect of the present invention, there is provided a method of removing false contours. The method includes detecting a contour area from an input image, and detecting a false contour area from the contour area using a contrast between pixels in the contour area, expanding the false contour area, and removing a false contour from the expanded false contour area.

The detection of the false contour area may include removing flat areas from the input image and detecting the contour area from the input image, separating an edge area and the false contour area from the contour area using the contrast between pixels in the contour area, and generating false contour direction information and false contour location information of the false contour area.

Direction information indicating a direction that maximizes a contrast between pixels in a predetermined area may be determined as the false contour direction information.

The direction that maximizes the contrast between pixels in the predetermined area may be classified into one of five directions corresponding to an angle of 0°, an angle of 45°, an angle of 90°, an angle of 135°, and a non-direction. Alternatively, the direction that maximizes the contrast between pixels in the predetermined area may be classified into one of eight directions corresponding to an angle of 0°, an angle of 45°, an angle of 90°, an angle of 135°, an angle of 180°, an angle of 225°, an angle of 270°, and an angle of 315°.

The non-direction may correspond to a situation when a difference between a maximum contrast and a minimum contrast is smaller than a predefined threshold.

The expansion of the false contour area may include generating a structural element, and expanding the false contour area by performing a binary morphology dilation operation according to the size and shape of the structural element.

The removal of the false contour may include determining a smoothing mask weight according to a distance to a center pixel where the false contour is detected, and determining an edge preservation mask weight according to a contrast with the center pixel, and performing filtering using the smoothing mask weight and the edge preservation mask weight.

The performing of filtering may include performing filtering using a bilateral filter.

The removal of the false contour may include performing neural network learning according to a direction of the false contour area, and generating a weight for pixels in the false contour area, removing the false contour in units of pixels by applying the weight according to the false contour direction information, and filtering pixels from which the false contour is removed and pixels adjacent to the pixels from which the false contour is removed.

The performing of filtering may include expanding a false contour filtering area one pixel at a time in a direction perpendicular to the direction of the false contour area, and stopping the expansion of the false contour filtering area when a false contour or an edge is encountered during the expansion of the false contour filtering area.

The performing of filtering may include performing filtering using an adaptive one-dimensional (1D) directional smoothing filter.

According to another aspect of the present invention, there is provided a method of removing false contours while preserving edges. The method includes determining a smoothing mask weight according to a distance from a pixel in a mask to a center pixel where a false contour is detected, and determining an edge preservation mask weight according to a contrast with the center pixel, and performing filtering using the smoothing mask weight and the edge preservation mask weight.

The performing of filtering may include performing filtering using a bilateral filter.

According to another aspect of the present invention, there is provided a method of removing false contours using neural networks. The method includes performing neural network learning according to a direction of a false contour area, and generating a weight for pixels in the false contour area, removing a false contour in units of pixels by applying the weight according to false contour direction information of the false contour area, and filtering pixels from which the false contour is removed and pixels adjacent to the pixels from which the false contour is removed.

The performing of filtering may include expanding a false contour filtering area one pixel at a time in a direction perpendicular to the direction of the false contour area, and stopping the expansion of the false contour filtering area when a false contour or an edge is encountered during the expansion of the false contour filtering area.

The performing of filtering may include filtering using an adaptive 1D directional smoothing filter.

According to another aspect of the present invention, there is provided an apparatus for removing false contours. The apparatus includes a false contour detection unit which detects a contour area from an input image, and detects a false contour area from the contour area using a contrast between pixels in the contour area, a false contour area expansion unit which expands the false contour area, and a false contour removal unit which removes a false contour from the expanded false contour area.

The false contour detection unit may include a contour detector which removes flat areas from the input image and detects the contour area from the input image, and a false contour separator which separates an edge area and the false contour area from the contour area using the contrast between pixels in the contour area, and generates false contour direction information and false contour location information of the false contour area.

The false contour area detection unit may include a structural element generator which generates a structural element, and a calculator which expands the false contour area by performing a binary morphology dilation operation according to the size and shape of the structural element.

The false contour removal unit may include a weight determiner which determines a smoothing mask weight according to a distance to a center pixel where the false contour is detected, and determines an edge preservation mask weight according to a contrast with the center pixel, and a false contour removal filter which performs filtering using the smoothing mask weight and the edge preservation mask weight.

The false contour removal filter may be a bilateral filter.

The false contour removal unit may include a neural network learning unit which performs neural network learning according to a direction of the false contour area, and generates a weight for pixels in the false contour area, a weight applicator which removes the false contour in units of pixels by applying the weight according to the false contour direction information, and a false contour removal filter which filters pixels from which the false contour is removed and pixels adjacent to the pixels from which the false contour is removed.

The false contour removal filter may include a filtering area expansion unit which expands a false contour filtering area one pixel at a time in a direction perpendicular to the direction of the false contour area and stops the expansion of the false contour filtering area when a false contour or an edge is encountered during the expansion of the false contour filtering area.

The false contour removal filter may be an adaptive 1D directional smoothing filter.

According to another aspect of the present invention, there is provided an apparatus for removing false contours while preserving edges. The apparatus includes a weight determiner which determines a smoothing mask weight according to a distance from a pixel in a mask to a center pixel where a false contour is detected, and determines an edge preservation mask weight according to a contrast with the center pixel, and a false contour removal filter which filters using the smoothing mask weight and the edge preservation mask weight.

The false contour removal filter may be a bilateral filter.

According to another aspect of the present invention, there is provided an apparatus for removing false contours using neural networks. The apparatus includes a neural network learning unit which performs neural network learning according to a direction of a false contour area, and generates a weight for pixels in the false contour area, a weight applicator which removes a false contour in units of pixels by applying the weight according to false contour direction information of the false contour area, and a false contour removal filter which filters pixels from which the false contour is removed and pixels adjacent to the pixels from which the false contour is removed.

The false contour removal filter may include a filtering area expansion unit which expands a false contour filtering area one pixel at a time in a direction perpendicular to the direction of the false contour area and stops the expansion of the false contour filtering area when a false contour or an edge is encountered during the expansion of the false contour filtering area.

The false contour removal filter may be an adaptive 1D directional smoothing filter.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram for explaining a conventional method of removing false contours;

FIG. 2 is a block diagram of an apparatus for removing false contours according to an exemplary embodiment of the present invention;

FIG. 3 is a diagram for explaining structural elements according to an exemplary embodiment of the present invention;

FIG. 4 is a flowchart illustrating a method of removing false contours while preserving edges according to an exemplary embodiment of the present invention;

FIG. 5 is a diagram for explaining the operation of a false contour detection unit illustrated in FIG. 2;

FIG. 6 is a block diagram of a false contour removal unit illustrated in FIG. 2;

FIG. 7 is a diagram of a first order weight function for explaining the determination of a weight according to an exemplary embodiment of the present invention;

FIG. 8 is a block diagram for explaining the operation of a neural network learning unit according to an exemplary embodiment of the present invention;

FIG. 9 is a block diagram of an apparatus for removing false contours using neural networks according to an exemplary embodiment of the present invention;

FIG. 10 is a diagram for explaining a method of expanding a false contour filtering area according to an exemplary embodiment of the present invention;

FIG. 11 is a diagram for explaining an example of the method illustrated in FIG. 10; and

FIG. 12 is a flowchart illustrating a method of removing false contours using neural networks according to an exemplary embodiment of the present invention.

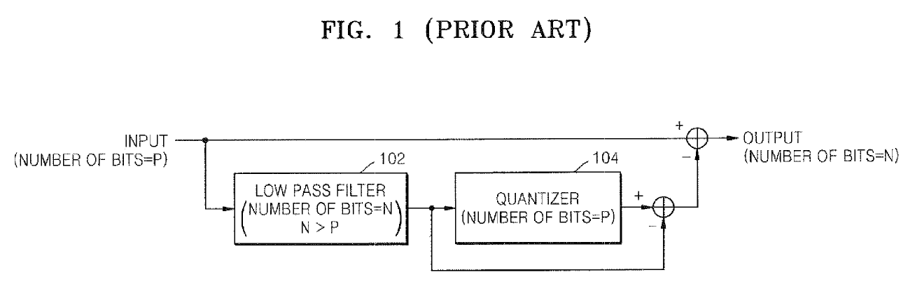

### DETAILED DESCRIPTION OF THE INVENTION

The present invention will now be described more fully with reference to the accompanying drawings in which exemplary embodiments of the invention are shown.

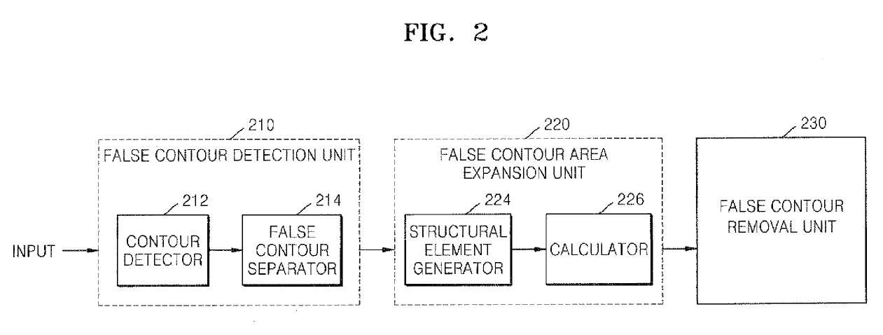

FIG. 2 is a block diagram of an apparatus for removing false contours according to an exemplary embodiment of the present invention. Referring to FIG. 2, the apparatus includes a false contour detection unit 210, a false contour area expansion unit 220, and a false contour removal unit 230.

The false contour detection unit 210 includes a contour detector 212 and a false contour separator 214.

The contour detector 212 removes flat areas from an input image using a difference between the input image and an image obtained by reducing the number of bits of the input image, and detects a contour area in the input image. The contour area comprises not only a false contour area but also an edge area.

The false contour separator 214 separates a false contour area and an edge area from the contour area obtained by the contour detector 212, and generates information (hereinafter referred to as false contour direction information) indicating the direction of the false contour area and information (hereinafter referred to as false contour location information) indicating the location of the false contour area.

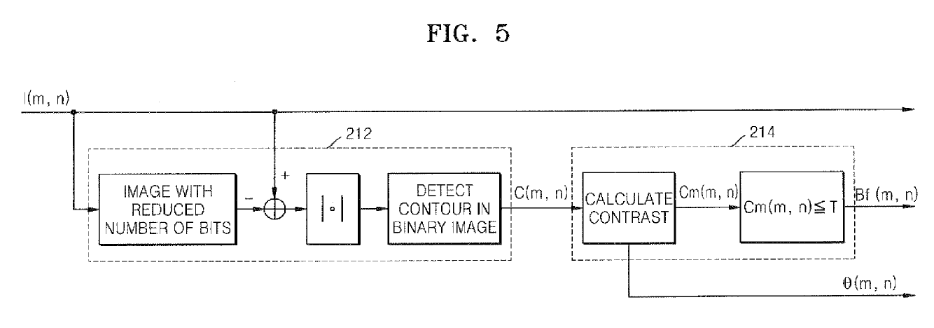

The operation of the false contour detection unit 210 will be described later in further detail with reference to FIG. 5.

The false contour area expansion unit 220 includes a structural element generator 224 and a calculator 226.

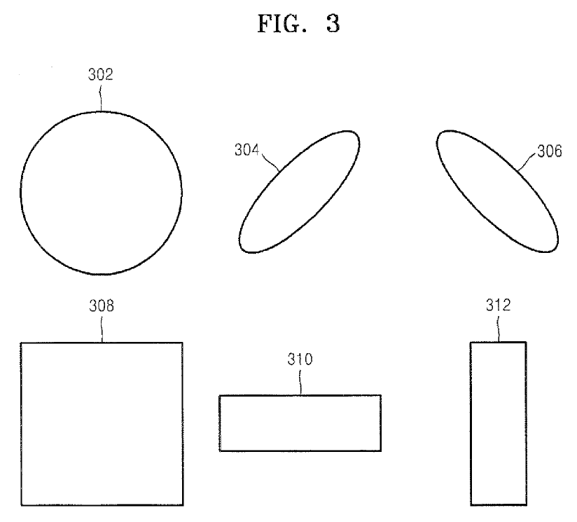

The structural element generator 224 generates a structural element that is needed to expand a false contour area. FIG. 3 is a diagram for illustrating structural elements according to an exemplary embodiment of the present invention. Referring to FIG. 3, the structural element generator 224 can generate various shapes of structural elements such as a circular structural element 302, oval structural elements 304 and 306, a square structural element 308, and rectangular structural elements 310 and 312.

The calculator 226 expands a false contour area, according to the size and shape of the structural element generated by the structural element generator 224, by performing a binary morphology dilation operation. If the structural element generated by the structural element generator 224 is circular, a false contour area is expanded to be as large as a circular mask by performing a binary morphology dilation operation.

Structural elements and a binary morphology dilation operation are obvious to one of ordinary skill in the art to which the present invention pertains, and thus detailed descriptions thereof will be skipped.

The false contour removal unit 230 determines a smoothing mask weight according to the distance from a pixel in the mask to a center pixel of a false contour, determines an edge preservation mask weight according to the contrast with the center pixel of the false contour, and removes the false contour by performing filtering using the smoothing mask weight and the edge preservation mask weight.

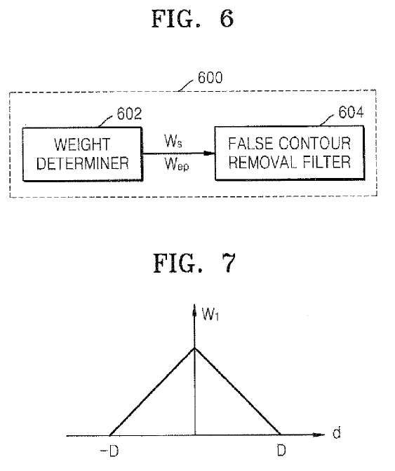

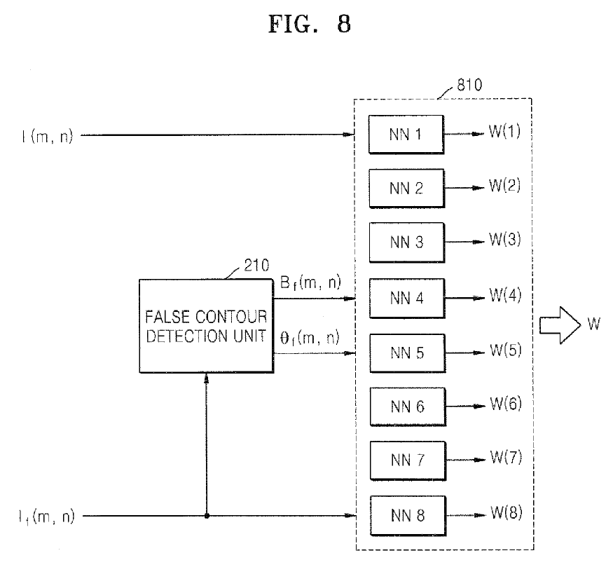

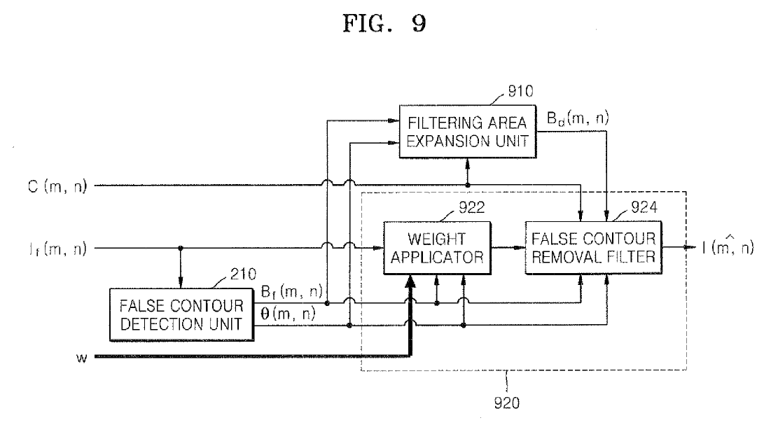

The operation of the false contour removal unit 230 will be described later in further detail with reference to FIGS. 6 and 7. According to the present exemplary embodiment, the false contour removal unit 230 may use neural networks to remove false contours, which will be described later in further detail with reference to FIGS. 8 through 11.

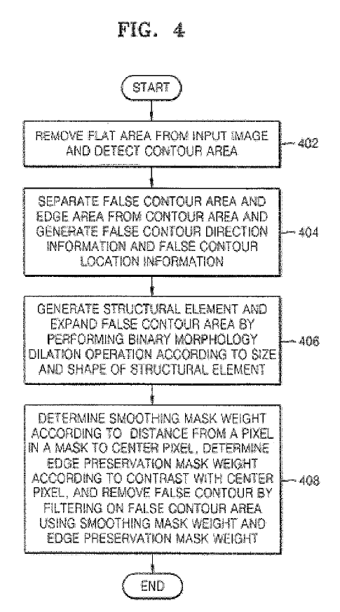

FIG. 4 is a flowchart illustrating a method of removing false contours while preserving edges according to an exemplary embodiment of the present invention. Referring to FIG. 4, in operation 402, flat areas are removed from an input image, and a contour area is detected from the resulting input image. In operation 404, a false contour area and an edge area are separated from the contour area obtained in operation 402, and false contour direction information and false contour location information are generated.

In operation 406, a structural element is generated, and the false contour area is expanded according to the size of the structural element by performing a binary morphology dilation operation.

In operation 408, a smoothing mask weight is determined according to the distance from a pixel in the mask to a center pixel of the false contour area an edge preservation mask weight is determined according to the contrast with the center pixel of the false contour area, and the false contour area is filtered using the smoothing mask weight and the edge preservation mask weight.

According to the present exemplary embodiment, in operation 408, neural networks may be used to remove a false contour, and this will be described later in further detail with reference to FIGS. 8 through 11.

FIG. 5 is a diagram for explaining the operation of the false contour detection unit 210 illustrated in FIG. 2. Referring to FIG. 2, the contour detector 212 calculates a difference between an input image I(m,n) (where m indicates a horizontal coordinate and n indicates a vertical coordinate) and an image obtained by reducing the number of bits of the input image I(m,n), and detects contour information C(m,n) from a binary image using the absolute value of the result of the calculation.

The false contour separator 214 separates a false contour area and an edge area from the contour information C(m,n), and generates false contour direction information and false contour location information.

In detail, the false contour direction information is generated based on the contour information C(m,n) of the input image I(m,n), as indicated by Equation (1):

$${Contrast}_{max} = Max ( \frac{{\sum }_{m = 0}^{K - 1} {\sum }_{n = 0}^{L - 2} {( I ( m , n ) - I ( m , n + 1 ) )}^{2}}{K ( L - 1 )} , \frac{{\sum }_{m = 0}^{K - 2} {\sum }_{n = 0}^{L - 1} {( I ( m , n ) - I ( m + 1 , n ) )}^{2}}{( K - 1 ) L} , \frac{{\sum }_{m = 0}^{K - 2} {\sum }_{n = 0}^{L - 2} {( I ( m , n ) - I ( m + 1 , n + 1 ) )}^{2}}{( K - 1 ) ( L - 1 )} , \frac{{\sum }_{m = 0}^{K - 1} {\sum }_{n = 0}^{L - 1} {( I ( m , n ) - I ( m - 1 , n - 1 ) )}^{2}}{( K - 1 ) ( L - 1 )} ) \qquad ( 1 )$$

where Contrastₘₐₓ indicates a maximum contrast, K indicates the size of a mask in a horizontal direction, and L indicates the size of the mask in a vertical direction. The four components parenthesized in Equation (1) respectively indicate horizontal false contour direction information corresponding to an angle of 0°, vertical false contour direction information corresponding to an angle of 90°, diagonal false contour direction information corresponding to an angle of 135°, and opposite false contour direction information corresponding to an angle of 180°, and are represented as θ^{h}, θ^{v}, θ^{d}, and θ^{ad}. A minimum contrast Contrastₘᵢₙ is calculated as indicated by Equation (2):

$${Contrast}_{min} = Min ( \frac{{\sum }_{m = 0}^{K - 1} {\sum }_{n = 0}^{L - 2} {( I ( m , n ) - I ( m , n + 1 ) )}^{2}}{K ( L - 1 )} , \frac{{\sum }_{m = 0}^{K - 2} {\sum }_{n = 0}^{L - 1} {( I ( m , n ) - I ( m + 1 , n ) )}^{2}}{( K - 1 ) L} , \frac{{\sum }_{m = 0}^{K - 2} {\sum }_{n = 0}^{L - 2} {( I ( m , n ) - I ( m + 1 , n + 1 ) )}^{2}}{( K - 1 ) ( L - 1 )} , \frac{{\sum }_{m = 0}^{K - 1} {\sum }_{n = 0}^{L - 1} {( I ( m , n ) - I ( m - 1 , n - 1 ) )}^{2}}{( K - 1 ) ( L - 1 )} ) . \qquad ( 2 )$$

According to the present exemplary embodiment, a non-direction θ^{nondir} is added as a type of direction. The non-direction θ^{nondir} can be determined to correspond to the situation when the difference between the maximum contrast Contrastₘₐₓ and the minimum contrast Contrastₘᵢₙ is less than a predefined threshold Th, as indicated by Equation (3):

Contrastₘₐₓ−Contastₘᵢₙ<Th (3).

Thereafter, a false contour area and an edge area are separated from the contour information C(m,n) according to whether the maximum contrast Contrastₘₐₓ (hereinafter referred to as the maximum contrast Cm(m,n)) is less than a predefined threshold T. In other words, an area where the maximum contrast Cm(m,n) is larger than the predefined threshold T is determined as an edge area, and an area where the maximum contrast Cm(m,n) is less than the predefined threshold T is determined as a false contour area. In this manner, false contour direction information θ(m,n) and false contour location information B_{f}(m,n) can be obtained.

However, the present invention is not restricted to the false contour detection method set forth herein.

FIG. 6 is a block diagram of an example of the false contour removal unit 230 illustrated in FIG. 2, i.e., a false contour removal unit 600. Referring to FIG. 6, the false contour removal unit 600 includes a weight determiner 602 and a false contour removal filter 604.

The weight determiner 602 determines a smoothing mask weight wₛ according to the distance from a pixel in the mask to a center pixel of a false contour area, and an edge preservation mask weight wₑₚ according to the contrast between a pixel in the mask and with the center pixel of the false contour area.

A weight function used to define each of the smoothing mask weight wₛ and the edge preservation mask weight wₑₚ may be defined by Equation (4):

$${w}^{1} ( d , D ) = \{ \begin{matrix} 1 - \frac{\vert d \vert}{D} , & \vert d \vert < D \\ 0 , & otherwise\end{matrix} \qquad ( 4 )$$

where d indicates an input variable, and D indicates the size in pixels of a mask. A brightness difference or a distance may be used as the input variable d, but the present invention is not restricted thereto.

FIG. 7 is a graph for illustrating a first order weight function and explains the determination of a weight. Referring to FIG. 7, the width of the first order weight function is 2D+1, and a weight is determined according to the value of the input variable d.

A second order weight function can be obtained by combining two first order weight functions, as indicated by Equation (5):

$${w}^{2} ( d , D ) = \{ \begin{matrix} ( 1 - \frac{\vert {d}_{1} \vert}{{D}_{1}} ) ( 1 - \frac{\vert {d}_{2} \vert}{{D}_{2}} ) , & \vert {d}_{1} \vert < {D}_{1} and \vert {d}_{2} \vert < {D}_{2} \\ 0 , & otherwise\end{matrix} . \qquad ( 5 )$$

In this manner, an n-th order weight function can be generalized as indicated by Equation (6):

$${w}^{n} ( d , D ) = \{ \begin{matrix} {\prod }_{k = 1}^{n} ( 1 - \frac{\vert {d}_{k} \vert}{{D}_{k}} ) , & \vert {d}_{k} \vert < {D}_{k} , k = 1 , 2 , … n \\ 0 , & otherwise\end{matrix} . \qquad ( 6 )$$

By using the n-th order weight function, a weight for an n-th input variable d=(d₁, . . . , dₙ) can be determined. The width of the n-th order weight function can be determined according to the mask size D=(D1, . . . , Dn). The first order weight function can be used for determining a weight according to the contrast between areas in a black-and-white image or determining a weight for a moving image according to the passage of time. The second order weight function can be used for determining a weight according to a distance between areas in an image. The third order weight function can be used for determining a weight according to a difference between the colors of areas in a color image.

However, the present invention is not restricted to the weight functions set forth herein.

The determination of a smoothing mask weight and an edge preservation mask weight using a weight function will hereinafter be described in further detail.

Assuming that a center pixel of a false contour area is x=(x1, x2) and a neighbor pixel in a smoothing mask is ξ=(ξ₁,ξ₂), a smoothing mask weight wₛ can be determined using a second order weight function, as indicated by Equation (7):

wₛ(ξ,x)=w²(ξ−x,M) (7)

where M=(M₁, M₂) indicates a parameter that is needed to determine the smoothing mask weight wₛ. Since the width of a weight function is the same as the size of a smoothing mask, the smoothing mask weight wₛ has a value of 0 outside the smoothing mask. As the size of the smoothing mask increases, false contours that are distant from each other can be more effectively removed. However, the larger the smoothing mask, the more likely it is to blur an image. Thus, there is the need to appropriately determine the smoothing mask weight wₛ.

An edge preservation mask weight wₑₚ is determined according to the contrast between the center pixel x and the neighbor pixel ξ using a first order weight function, as indicated by Equation (8):

wₑₚ(ξ,x)=w¹(ΔI,ΔI [symbol] )

ΔI=I(ξ)−I(x) (8)

where Δi indicates the contrast between the center pixel x and the neighbor pixel ξ, and ΔI [symbol] indicates a parameter that is needed to determine the edge preservation mask weight wₑₚ and is determined based a maximum contrast detected in a false contour area by a user. If Δl is smaller than ΔI [symbol] , an edge preservation mask considers the neighbor pixel ξ when performing filtering. However, if ΔI [symbol] is smaller than Δl, the edge preservation mask does not consider the neighbor pixel ξ when performing filtering. In this manner, false contours can be effectively removed while preserving edge areas.

The brightness of each pixel of a black-and-white image is represented by a single value, and thus, a weight for a black-and-white image can be determined in the aforementioned manner. On the other hand, the brightness of each pixel of a color image is represented by three values, i.e., R, G, and B, and thus, a weight for a color image can be determined using a third order weight function, as indicated by Equation (9):

wₑₚ(ξ,x(=w³(ΔI,ΔI_{fx})

ΔI=I(ξ)−I(x) (9)

where ΔI is a color plane vector indicating the contrast between the center pixel x and the neighbor pixel ξ, and I(x) indicates the brightness of a color image. The brightness I(x) may be represented by a value of a YCbCr plane or a value of a CIE L*a*b* plane as well as a value of an RGB plane. The parameter ΔI [symbol] in Equation (8) is replaced by a vector ΔI_{fx} in Equation (9).

Once the smoothing mask weight wₛ and the edge preservation mask weight wₑₚ are determined in the aforementioned manner, a false contour is removed by performing filtering on a false contour area using a weight that is obtained by multiplying the smoothing mask weight wₛ by the edge preservation mask weight wₑₚ and normalizing the result of the multiplication. This type of filtering is referred to as bilateral filtering, and is indicated by Equation (10):

$$\tilde{I} ( x ) = \{ \begin{matrix} \frac{{\sum }_{ξ ∈ {N}_{x}} I ( ξ ) {w}_{s} ( ξ , x ) {w}_{ep} ( ξ , x )}{{\sum }_{ξ ∈ {N}_{x}} {w}_{s} ( ξ , x ) {w}_{ep} ( ξ , x )} , & {\tilde{ B}}_{fc} = 1 \\ I ( x ) , & otherwise\end{matrix} \qquad ( 10 )$$

were Nₓ indicates a mask whose center is x.

However, the present invention is not restricted to bilateral filtering. In other words, a variety of filtering methods other than a bilateral filtering method may be used.

The removal of false contours using a bilateral filtering method has been described in detail so far. Hereinafter, the removal of false contours using neural networks will be described in detail.

FIG. 8 is a block diagram for explaining the operation of a neural network learning unit according to an exemplary embodiment of the present invention. Referring to FIG. 8, neural network learning aims at adaptively performing filtering and thus minimizing deterioration of signal components. According to the present exemplary embodiment, neural network learning is performed using a neural network unit 810, which comprises eight neural networks 810, in consideration of a total of eight false contour directions (0°, 45°, 90°, 135°, 180°, 225°, 270°, and 315°) in order to adaptively perform filtering according to each false contour direction.

An original input image I(m,n), an image If(m,n) including false contours, and false contour location information Bf(m,n) and false contour direction information θ(m,n) provided by the false contour detection unit 210 are input to the neural network unit 810. Pixels where a false contour is detected are represented by the equation Bf(m,n)=1, and pixels where no false contour is detected are represented by the equation Bf(m,n)=0. A weight can be determined by learning of the neural network learning unit 810, as indicated by Equation (11):

W=[W(1),W(2),W(3),W(4),W(5),W(6),W(7),W(8)] (11)

where W(k) (1≦k=└θ(x,y)/45┘+1≦8) indicates the weight determined by the learning of the neural network unit 810, and └α┘ indicates the closest integer smaller than α.

Each of the eight neural networks corresponding to the respective false contour directions comprises an input layer consisting of L nodes, a hidden layer consisting of M nodes, and an output layer consisting of N nodes. An input to each of the eight neural networks is obtained from a location in the image I_{f}(m,n) corresponding to a pixel in a mask that comprises L pixels surrounding a pixel where a false contour is detected and a target value is obtained from a location in the original input image I(m,n) corresponding to a center pixel of the mask.

FIG. 9 is a block diagram of an apparatus for removing false contours using neural networks according to an exemplary embodiment of the present invention. For convenience of description, a false contour detection unit 210 is illustrated, and a weight w, which is the output of a neural network learning unit 810, is illustrated instead of the neural network learning unit 810.

Referring to FIG. 9, a filtering area expansion unit 910 expands an area (hereinafter referred to as a false contour filtering area) where filtering is to be performed based on false contour direction information θ(m,n), false contour location information Bf(m,n), and contour information C(m,n). In general, a difference in the values of a pair of adjacent pixels in an area where a false contour is detected is considerable. In this case, a false contour may not be able to be properly removed simply by varying the values of pixels where the false contour is detected. Thus, according to the present exemplary embodiment, a false contour is removed by expanding a false contour filtering area so that not only pixels where a false contour is detected but also pixels adjacent to the pixels where a false contour is detected can be filtered.

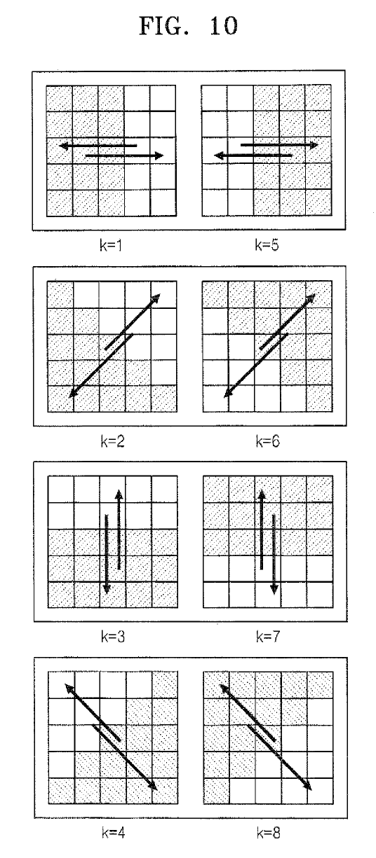

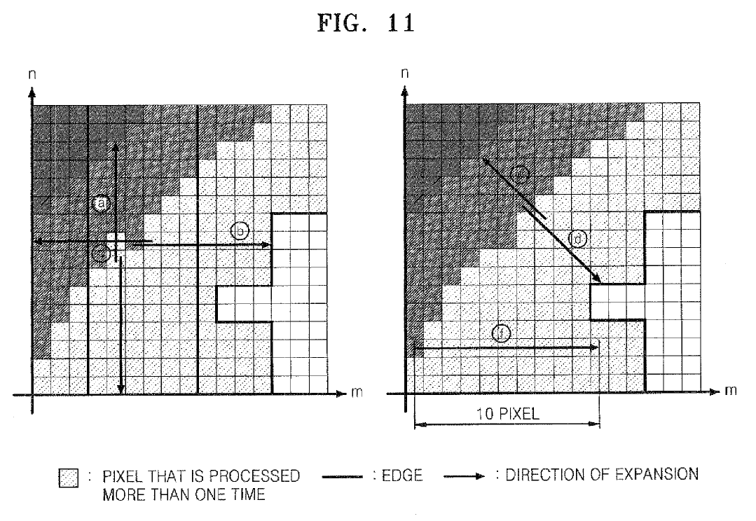

FIG. 10 is a diagram for explaining a false contour filtering area according to an exemplary embodiment of the present invention. Referring to FIG. 10, the expansion of a false contour filtering area is performed in a direction perpendicular to the direction of a false contour. The amount by which a false contour filtering area is expanded, i.e., an expansion distance E, may be up to 10 (E=10). When a false contour or an edge is encountered during the expansion of a false contour filtering area, the false contour filtering area is not expanded any further.

Here, the expansion distance may be 10 or greater in an another exemplary embodiment.

Referring to FIG. 9, the filtering area expansion unit 910 outputs filtering area expansion information Bd(m,n) indicating both pixels to be incorporated into an expanded false contour filtering area and pixels not to be incorporated into the expanded false contour filtering area. Pixels to be incorporated into an expanded false contour filtering area are represented by the equation Bd(m,n)=1, and pixels not to be incorporated into an expanded false contour filtering area are represented by the equation Bd(m,n)=0.

FIG. 11 is a diagram for explaining an example of the method illustrated in FIG. 10. Referring to FIG. 11, (a) illustrates the situation when the expansion of a false contour filtering area in a direction perpendicular to a horizontal false contour is stopped after an encounter with a false contour adjacent to the horizontal false contour, (b) illustrates the situation when the expansion of a false contour filtering area in a direction perpendicular to a vertical false contour is stopped after an encounter with an edge adjacent to the vertical false contour, (c) illustrates pixels that are processed more than one time during the expansion of a false contour filtering area, (d) illustrates a similar situation as the situation illustrated by (b), i.e., the situation when the expansion of a false contour filtering area is stopped after an encounter with an edge, (e) illustrates a similar situation as the situation illustrated by (a), i.e., the situation when the expansion of a false contour filtering area is stopped after an encounter with a false contour, and (f) illustrates the situation when the false contour filtering area is expanded to its maximum (E=10) and then the expansion is stopped. In a case where pixels are processed more than one time during the expansion of a false contour filtering area, as indicated by (c) of FIG. 11, the values of pixels incorporated into the expanded false contour filtering area can be calculated according to the direction of a false contour, as indicated by Equations (12) through (15):

$$\begin{matrix}False Contour Direction \text{:} k = 1 \\ \hat{I} ( m + i , n ) = \{ \begin{matrix}\begin{matrix}\frac{r}{r + 1} \hat{I} ( m + i , n ) + \frac{r}{r + 1} \{ \frac{{d}_{1}}{{D}_{1}} \\ ( {I}_{f}^{′} ( m + X , n ) - {I}_{f}^{′} ( m , n ) ) + {I}_{f}^{′} ( m , n ) \} ,\end{matrix} & \begin{matrix}if {B}_{d} ( m + i , n ) = \\ 1 \& {I}_{f}^{′} ( m + 1 , n ) > {I}_{f}^{′} ( m , n )\end{matrix} \\ \begin{matrix}\frac{r}{r + 1} \hat{I} ( m + i , n ) + \frac{r}{r + 1} \{ \frac{{d}_{2}}{{D}_{2}} \\ ( {I}_{f}^{′} ( m - X , n ) - {I}_{f}^{′} ( m , n ) ) + {I}_{f}^{′} ( m , n ) \} ,\end{matrix} & \begin{matrix}if {B}_{d} ( m + i , n ) = \\ 1 \& {I}_{f}^{′} ( m - 1 , n ) > {I}_{f}^{′} ( m , n )\end{matrix} \\ {I}_{f}^{′} ( m + i , n ) , & otherwise\end{matrix} \\ False Contour Direction \text{:} k = 5 \\ \hat{I} ( m + i , n ) = \{ \begin{matrix}\begin{matrix}\frac{r}{r + 1} \hat{I} ( m + i , n ) + \frac{r}{r + 1} \{ \frac{{d}_{1}}{{D}_{1}} \\ ( {I}_{f}^{′} ( m - X , n ) - {I}_{f}^{′} ( m , n ) ) + {I}_{f}^{′} ( m , n ) \} ,\end{matrix} & \begin{matrix}if {B}_{d} ( m + i , n ) = \\ 1 \& {I}_{f}^{′} ( m - 1 , n ) > {I}_{f}^{′} ( m , n )\end{matrix} \\ \begin{matrix}\frac{r}{r + 1} \hat{I} ( m + i , n ) + \frac{r}{r + 1} \{ \frac{{d}_{2}}{{D}_{2}} \\ ( {I}_{f}^{′} ( m + X , n ) - {I}_{f}^{′} ( m , n ) ) + {I}_{f}^{′} ( m , n ) \} ,\end{matrix} & \begin{matrix}if {B}_{d} ( m + i , n ) = \\ 1 \& {I}_{f}^{′} ( m + 1 , n ) > {I}_{f}^{′} ( m , n )\end{matrix} \\ {I}_{f}^{′} ( m + i , n ) , & otherwise\end{matrix} \\ & ( 12 ) \\ FalseContourDirectionk = 2 \\ \hat{I} ( m + i , n + j ) = \{ \begin{matrix}\begin{matrix}\frac{r}{r + 1} \hat{I} ( m + i , n + j ) + \frac{r}{r + 1} \{ \frac{{d}_{1}}{{D}_{1}} \\ ( {I}_{f}^{′} ( m + X , n + Y ) - {I}_{f}^{′} ( m , n ) ) + {I}_{f}^{′} ( m , n ) \} ,\end{matrix} & \begin{matrix}if {B}_{d} ( m + i , n + j ) = \\ 1 \& {I}_{f}^{′} ( m + 1 , n + 1 ) > {I}_{f}^{′} ( m , n )\end{matrix} \\ \begin{matrix}\frac{r}{r + 1} \hat{I} ( m + i , n + j ) + \frac{r}{r + 1} \{ \frac{{d}_{2}}{{D}_{2}} \\ ( {I}_{f}^{′} ( m - X , n - Y ) - {I}_{f}^{′} ( m , n ) ) + {I}_{f}^{′} ( m , n ) \} ,\end{matrix} & \begin{matrix}if {B}_{d} ( m + i , n + j ) = \\ 1 \& {I}_{f}^{′} ( m - 1 , n - 1 ) > {I}_{f}^{′} ( m , n )\end{matrix} \\ {I}_{f}^{′} ( m + i , n + j ) , & otherwise\end{matrix} \\ FalseContourDirectionk = 6 \\ \hat{I} ( m + i , n + j ) = \{ \begin{matrix}\begin{matrix}\frac{r}{r + 1} \hat{I} ( m + i , n + j ) + \frac{r}{r + 1} \{ \frac{{d}_{1}}{{D}_{1}} \\ ( {I}_{f}^{′} ( m - X , n - Y ) - {I}_{f}^{′} ( m , n ) ) + {I}_{f}^{′} ( m , n ) \} ,\end{matrix} & \begin{matrix}if {B}_{d} ( m + i , n + j ) = \\ 1 \& {I}_{f}^{′} ( m - 1 , n - 1 ) > {I}_{f}^{′} ( m , n )\end{matrix} \\ \begin{matrix}\frac{r}{r + 1} \hat{I} ( m + i , n + j ) + \frac{r}{r + 1} \{ \frac{{d}_{2}}{{D}_{2}} \\ ( {I}_{f}^{′} ( m + X , n + Y ) - {I}_{f}^{′} ( m , n ) ) + {I}_{f}^{′} ( m , n ) \} ,\end{matrix} & \begin{matrix}if {B}_{d} ( m + i , n + j ) = \\ 1 \& {I}_{f}^{′} ( m + 1 , n ) > {I}_{f}^{′} ( m , n + 1 )\end{matrix} \\ {I}_{f}^{′} ( m + i , n + j ) , & otherwise\end{matrix} & ( 13 ) \\ False Contour Direction \text{:} k = 3 \\ \hat{I} ( m , n + j ) = \{ \begin{matrix}\begin{matrix}\frac{r}{r + 1} \hat{I} ( m , n + j ) + \frac{r}{r + 1} \{ \frac{{d}_{1}}{{D}_{1}} \\ ( {I}_{f}^{′} ( m , n + Y ) - {I}_{f}^{′} ( m , n ) ) + {I}_{f}^{′} ( m , n ) \} ,\end{matrix} & \begin{matrix}if {B}_{d} ( m , n + j ) = \\ 1 \& {I}_{f}^{′} ( m , n + 1 ) > {I}_{f}^{′} ( m , n )\end{matrix} \\ \begin{matrix}\frac{r}{r + 1} \hat{I} ( m , n + j ) + \frac{r}{r + 1} \{ \frac{{d}_{2}}{{D}_{2}} \\ ( {I}_{f}^{′} ( m , n - Y ) - {I}_{f}^{′} ( m , n ) ) + {I}_{f}^{′} ( m , n ) \} ,\end{matrix} & \begin{matrix}if {B}_{d} ( m , n + j ) = \\ 1 \& {I}_{f}^{′} ( m , n - 1 ) > {I}_{f}^{′} ( m , n )\end{matrix} \\ {I}_{f}^{′} ( m , n + j ) , & otherwise\end{matrix} \\ False Contour Direction \text{:} k = 7 \hat{I} ( m , n + j ) = \{ \begin{matrix}\begin{matrix}\frac{r}{r + 1} \hat{I} ( m , n + j ) + \frac{r}{r + 1} \{ \frac{{d}_{1}}{{D}_{1}} \\ ( {I}_{f}^{′} ( m , n - Y ) - {I}_{f}^{′} ( m , n ) ) + {I}_{f}^{′} ( m , n ) \} ,\end{matrix} & \begin{matrix}if {B}_{d} ( m , n + j ) = \\ 1 \& {I}_{f}^{′} ( m , n - 1 ) > {I}_{f}^{′} ( m , n )\end{matrix} \\ \begin{matrix}\frac{r}{r + 1} \hat{I} ( m , n + j ) + \frac{r}{r + 1} \{ \frac{{d}_{2}}{{D}_{2}} \\ ( {I}_{f}^{′} ( m , n + Y ) - {I}_{f}^{′} ( m , n ) ) + {I}_{f}^{′} ( m , n ) \} ,\end{matrix} & \begin{matrix}if {B}_{d} ( m , n + j ) = \\ 1 \& {I}_{f}^{′} ( m , n + 1 ) > {I}_{f}^{′} ( m , n )\end{matrix} \\ {I}_{f}^{′} ( m , n + j ) , & otherwise\end{matrix} & ( 14 ) \\ FalseContourDirectionk = 4 \\ \hat{I} ( m + i , n + j ) = \{ \begin{matrix}\begin{matrix}\frac{r}{r + 1} \hat{I} ( m + i , n + j ) + \frac{r}{r + 1} \{ \frac{{d}_{1}}{{D}_{1}} \\ ( {I}_{f}^{′} ( m - X , n + Y ) - {I}_{f}^{′} ( m , n ) ) + {I}_{f}^{′} ( m , n ) \} ,\end{matrix} & \begin{matrix}if {B}_{d} ( m + i , n + j ) = \\ 1 \& {I}_{f}^{′} ( m - 1 , n + 1 ) > {I}_{f}^{′} ( m , n )\end{matrix} \\ \begin{matrix}\frac{r}{r + 1} \hat{I} ( m + i , n + j ) + \frac{r}{r + 1} \{ \frac{{d}_{2}}{{D}_{2}} \\ ( {I}_{f}^{′} ( m + X , n - Y ) - {I}_{f}^{′} ( m , n ) ) + {I}_{f}^{′} ( m , n ) \} ,\end{matrix} & \begin{matrix}if {B}_{d} ( m + i , n + j ) = \\ 1 \& {I}_{f}^{′} ( m + 1 , n - 1 ) > {I}_{f}^{′} ( m , n )\end{matrix} \\ {I}_{f}^{′} ( m + i , n + j ) , & otherwise\end{matrix} \\ FalseContourDirectionk = 8 \\ \hat{I} ( m + i , n + j ) = \{ \begin{matrix}\begin{matrix}\frac{r}{r + 1} \hat{I} ( m + i , n + j ) + \frac{r}{r + 1} \{ \frac{{d}_{1}}{{D}_{1}} \\ ( {I}_{f}^{′} ( m + X , n - Y ) - {I}_{f}^{′} ( m , n ) ) + {I}_{f}^{′} ( m , n ) \} ,\end{matrix} & \begin{matrix}if {B}_{d} ( m + i , n + j ) = \\ 1 \& {I}_{f}^{′} ( m + 1 , n - 1 ) > {I}_{f}^{′} ( m , n )\end{matrix} \\ \begin{matrix}\frac{r}{r + 1} \hat{I} ( m + i , n + j ) + \frac{r}{r + 1} \{ \frac{{d}_{2}}{{D}_{2}} \\ ( {I}_{f}^{′} ( m - X , n - Y ) - {I}_{f}^{′} ( m , n ) ) + {I}_{f}^{′} ( m , n ) \} ,\end{matrix} & \begin{matrix}if {B}_{d} ( m + i , n + j ) = \\ 1 \& {I}_{f}^{′} ( m - 1 , n + 1 ) > {I}_{f}^{′} ( m , n )\end{matrix} \\ {I}_{f}^{′} ( m + i , n + j ) , & otherwise\end{matrix} & ( 15 )\end{matrix}$$

where d₁ or d₂ indicates a distance between a pixel incorporated into an expanded false contour filtering area and a pixel where a false contour is detected, D₁ or D₂ indicates the length in pixels by which a false contour filtering area is expanded, and r indicates the number of iterations of processing of a pixel during the expansion of a false contour filtering area and is equal to 0 for pixels that are processed for a first time. Equations (12) through (15) respectively correspond to pairs of false contour directions illustrated in FIG. 10, each pair of false contour directions that form an angle of 180°. The distances d₁ and d₂ can be defined by Equation (16):

d₁=|i| or |j|, and d₂=|i| or |j| (16)

where i indicates a horizontal pixel distance, and j indicates a vertical pixel distance.

The lengths D₁ and D₂ can be defined by Equation (17):

D₁=X or Y

D₂=X or Y (17)

where X indicates the length in a horizontal direction by which a false contour filtering area is expanded, and Y indicates the length in a vertical direction by which a false contour filtering area is expanded.

Referring to FIG. 11, in the case of (d), I_{f}′(m+1,n−1)>I_{f}′(m,n). Thus, a false contour filtering area is expanded in a direction that satisfies the equation: k=8; and D₁=4. On the other hand, in the case of (e), D₂=3. In a case where a false contour filtering area is expanded in a total of eight directions, like in the present exemplary embodiment, the absolute values of the horizontal pixel distance i and the vertical pixel distance j are the same for a diagonal false contour direction and an anti-diagonal false contour direction.

Referring to FIG. 9, a weight applicator 922 applies a weight using the weight w, which is obtained by neural network learning, the false contour location information B_{f}(m,n), the false contour direction information θ(m,n), and the image I_{f}(m,n) and outputs an image I_{f}′(m, n) as a result of primary false contour removal, as indicated by Equation (18):

$${I}_{f}^{f} ( m , n ) = \{ \begin{matrix} {\sum }_{i = 1}^{M} {c}_{i}^{1} {w}_{i , 1}^{2} ( k ) + {b}_{i}^{2} , & if {B}_{f} ( m , n ) = 1 \\ {I}_{f} ( m , n ) , & otherwise\end{matrix} \qquad ( 18 )$$

where cᵢ¹ indicates a value obtained from an intermediate calculation process performed by a neural network. The value cᵢ¹ can be defined by Equation (19):

$${c}_{i}^{1} = {\sum }_{j = 1}^{L} {p}_{j} {w}_{j , i}^{1} ( k ) + {b}_{i}^{1} \qquad ( 19 )$$

where the superscript of 1 in w_{j,i}¹(k) indicates a location of layer, the subscripts of i and j in w_{j,i}¹(k) indicate a location of node in two consecutive layers, bᵢ¹ indicates a bias, the superscript of 1 in bᵢ¹ indicates location of layer, and the subscript of i in bᵢ¹ indicates a location of node.

A false contour removal filter 924 applies an adaptive one-dimensional (1D) directional smoothing filter to the image I_{f}′(m,n) provided by the weight applicator 922, and outputs an image Î(m, n) as a result of final false contour removal. Here, the false contour removal filter 924 is not restricted to an adaptive 1D directional smoothing filter, and this will hereinafter be described in detail.

The false contour removal filter 924 uses the false contour direction information θ(m,n), the false contour location information B_{f}(m,n), the contour information C(m,n), and the filtering area expansion information B_{d}(m,n) to perform filtering in a direction perpendicular to a false contour direction indicated by the false contour direction information θ(m,n). If the false contour removal filter 924 is a 9-tap smoothing filter, an adaptive 1D directional smoothing filter coefficient h(n) may be defined by Equation (20):

$$h ( n ) = \frac{1}{16} \times \{ 1 , 1 , 2 , 2 , 4 , 2 , 2 , 1 , 1 \} . \qquad ( 20 )$$

The false contour removal filter 924 performs filtering using the adaptive 1D directional smoothing filter coefficient h(n), thereby obtaining the image Î(m, n). The present invention is not restricted to a 9-tap smoothing filter. In other words, a 5-tap or 7-tap smoothing filter coefficient may be selectively applied to the present invention.

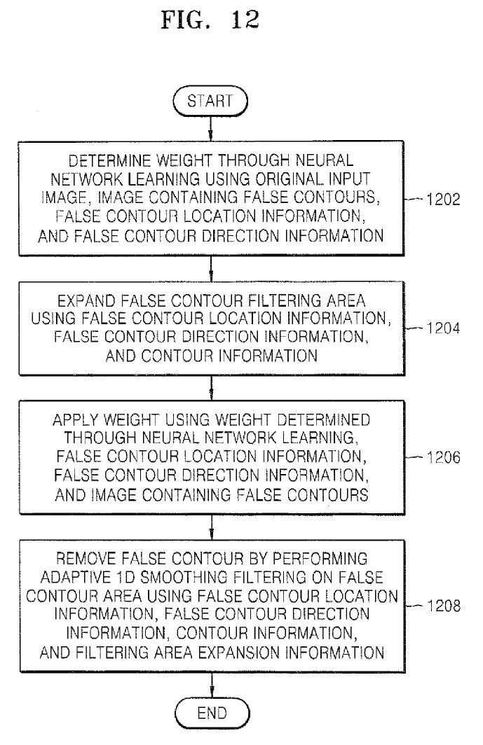

neural networks according to an exemplary embodiment of the present invention. Referring to FIG. 12, in operation 1202, a weight is determined through neural network learning using an original input image, an image containing false contours, false contour location information, and false contour direction information.

In operation 1204, a false contour filtering area is expanded using the false contour location information, the false contour direction information, and contour information.

In operation 1206, a weight is applied using the weight obtained in operation 1202, the false contour location information, the false contour direction information, and the image containing false contours.

In operation 1208, a false contour is removed from a false contour area by performing adaptive 1D smoothing filtering using the false contour location information, the false contour direction information, the contour information, and filtering area expansion information.

The present invention can be realized as computer-readable code embodied on a computer-readable recording medium. The computer-readable recording medium may be any type of recording device in which data is stored in a computer-readable manner. Non-limiting examples of the computer-readable recording medium include a ROM, a RAM, a CD-ROM, a magnetic tape, a floppy disc, an optical data storage, and a carrier wave (e.g., data transmission through the Internet). The computer-readable recording medium may be distributed over a plurality of computer systems connected to a network so that computer-readable code is written thereto and executed therefrom in a decentralized manner. Functional programs, code, and code segments needed for realizing the present invention can be easily construed by one of ordinary skill in the art.

According to the present invention, it is possible to remove false contours even when it is unknown what has caused the false contours, by detecting a false contour area candidate and performing false contour removal only on the detected false contour area candidate. In addition, according to the present invention, it is possible to enhance the quality of images by performing filtering while preserving edges in an original input image and precisely performing pixel-based processes through neural network learning.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of removing false contours comprising:
detecting a contour area from an input image;
detecting a false contour area from the contour area using a contrast between pixels in the contour area;
expanding the false contour area; and
removing a false contour from the expanded false contour area.

2. The method of claim 1, wherein the detecting the false contour area comprises:
removing flat areas from the input image;
detecting the contour area from the input image;
separating an edge area and the false contour area from the contour area using the contrast between pixels in the contour area; and
generating false contour direction information and false contour location information of the false contour area.

3. The method of claim 2, wherein direction information indicating a direction that maximizes a contrast between pixels in a predetermined area is determined as the false contour direction information.

4. The method of claim 3, wherein the direction that maximizes the contrast between pixels in the predetermined area is classified into one of five directions that comprise a direction corresponding to an angle of 0°, a direction corresponding to an angle of 45°, a direction corresponding to an angle of 90°, a direction corresponding to an angle of 135°, and a non-direction.

5. The method of claim 3, wherein the direction that maximizes the contrast between pixels in the predetermined area is classified into one of eight directions that comprise the direction corresponding to an angle of 0°, the direction corresponding to an angle of 45°, the direction corresponding to an angle of 90°, the direction corresponding to an angle of 135°, a direction corresponding to an angle of 180°, a direction corresponding to an angle of 225°, a direction corresponding to an angle of 270°, and a direction corresponding to an angle of 315°.

6. The method of claim 4, wherein the non-direction corresponds to a situation when a difference between a maximum contrast and a minimum contrast is smaller than a predefined threshold.

7. The method of claim 2, wherein the expanding the false contour area comprises:
generating a structural element; and
expanding the false contour area by performing a binary morphology dilation operation according to the size and shape of the structural element.

8. The method of claim 1, wherein the removing the false contour comprises:
determining a smoothing mask weight according to a distance to a center pixel where the false contour is detected, and determining an edge preservation mask weight according to a contrast with the center pixel; and
performing filtering using the smoothing mask weight and the edge preservation mask weight.

9. The method of claim 8, wherein the performing filtering comprises performing filtering using a bilateral filter.

10. The method of claim 1, wherein the removing the false contour comprises:
performing neural network learning according to a direction of the false contour area, and generating a weight for pixels in the false contour area;
removing the false contour in units of pixels by applying the weight according to the false contour direction information; and
filtering pixels from which the false contour is removed and pixels adjacent to the pixels from which the false contour is removed.

11. The method of claim 10, wherein the filtering comprises:
expanding a false contour filtering area one pixel at a time in a direction perpendicular to the direction of the false contour area; and
stopping the expansion of the false contour filtering area when a false contour or an edge is encountered during the expansion of the false contour filtering area.

12. The method of claim 10, wherein the filtering comprises filtering using an adaptive one-dimensional directional smoothing filter.

13. A method of removing false contours while preserving edges comprising:
determining a smoothing mask weight according to a distance from a pixel in a mask to a center pixel where a false contour is detected;
determining an edge preservation mask weight according to a contrast with the center pixel; and
filtering using the smoothing mask weight and the edge preservation mask weight.

14. The method of claim 13, wherein the filtering comprises performing filtering using a bilateral filter.

15. A method of removing false contours using neural networks comprising:
performing neural network learning according to a direction of a false contour area;
generating a weight for pixels in the false contour area;
removing a false contour in units of pixels by applying the weight according to false contour direction information of the false contour area; and
filtering pixels from which the false contour is removed and pixels adjacent to the pixels from which the false contour is removed.

16. The method of claim 15, wherein the filtering comprises:
expanding a false contour filtering area one pixel at a time in a direction perpendicular to the direction of the false contour area; and
stopping the expansion of the false contour filtering area when a false contour or an edge is encountered during the expansion of the false contour filtering area.

17. The method of claim 15, wherein the filtering comprises filtering using an adaptive one-dimensional directional smoothing filter.

18. An apparatus for removing false contours comprising:
a false contour detection unit which detects a contour area from an input image, and detects a false contour area from the contour area using a contrast between pixels in the contour area;
a false contour area expansion unit which expands the false contour area; and
a false contour removal unit which removes a false contour from the expanded false contour area.

19. The apparatus of claim 18, wherein the false contour detection unit comprises:
a contour detector which removes flat areas from the input image and detects the contour area from the input image; and
a false contour separator which separates an edge area and the false contour area from the contour area using the contrast between pixels in the contour area, and generates false contour direction information and false contour location information of the false contour area.

20. The apparatus of claim 18, wherein the false contour area detection unit comprises:
a structural element generator which generates a structural element; and
a calculator which expands the false contour area by performing a binary morphology dilation operation according to the size and shape of the structural element.

21. The apparatus of claim 18, wherein the false contour removal unit comprises:
a weight determiner which determines a smoothing mask weight according to a distance from a pixel in a mask to a center pixel where the false contour is detected, and determines an edge preservation mask weight according to a contrast with the center pixel; and
a false contour removal filter which filters using the smoothing mask weight and the edge preservation mask weight.

22. The apparatus of claim 21, wherein the false contour removal filter is a bilateral filter.

23. The apparatus of claim 18, wherein the false contour removal unit comprises:
a neural network learning unit which performs neural network learning according to a direction of the false contour area, and generates a weight for pixels in the false contour area;
a weight applicator which removes the false contour in units of pixels by applying the weight according to the false contour direction information; and
a false contour removal filter which filters pixels from which the false contour is removed and pixels adjacent to the pixels from which the false contour is removed.

24. The apparatus of claim 23, wherein the false contour removal filter comprises a filtering area expansion unit which expands a false contour filtering area one pixel at a time in a direction perpendicular to the direction of the false contour area and stops the expansion of the false contour filtering area when a false contour or an edge is encountered during the expansion of the false contour filtering area.

25. The apparatus of claim 23, wherein the false contour removal filter is an adaptive one-dimensional directional smoothing filter.

26. An apparatus for removing false contours while preserving edges comprising:
a weight determiner which determines a smoothing mask weight according to a distance from a pixel in a mask to a center pixel where a false contour is detected, and determines an edge preservation mask weight according to a contrast with the center pixel; and
a false contour removal filter which filter using the smoothing mask weight and the edge preservation mask weight.

27. The apparatus of claim 26, wherein the false contour removal filter is a bilateral filter.

28. An apparatus for removing false contours using neural networks comprising:
a neural network learning unit which performs neural network learning according to a direction of a false contour area, and generates a weight for pixels in the false contour area;
a weight applicator which removes a false contour in units of pixels by applying the weight according to false contour direction information of the false contour area; and
a false contour removal filter which filters pixels from which the false contour is removed and pixels adjacent to the pixels from which the false contour is removed.

29. The apparatus of claim 28, wherein the false contour removal filter comprises a filtering area expansion unit which expands a false contour filtering area one pixel at a time in a direction perpendicular to the direction of the false contour area and stops the expansion of the false contour filtering area when a false contour or an edge is encountered during the expansion of the false contour filtering area.

30. The apparatus of claim 28, wherein the false contour removal filter is an adaptive one-dimensional directional smoothing filter.

31. A computer-readable recording medium having recorded thereon a program for executing the method of claim 1.

32. A computer-readable recording medium having recorded thereon a program for executing the method of claim 13.

33. A computer-readable recording medium having recorded thereon a program for executing the method of claim 15.
